(19) United States
(12) Patent Application Publication
(10) Pub. No.: US 2006/0125634 A1
(43) Pub. Date: Jun. 15, 2006

(54) Method of safeguarding electronic devices

(76) Inventor: Oliver Schreyer, Herzogenrath (DE)

Correspondence Address: PHILIPS INTELLECTUAL PROPERTY & STANDARDS, P.O. BOX 3001, BRIARCLIFF MANOR, NY, 10510, US

(21) Appl. No.: 10/559,055

(22) PCT Filed: May 27, 2004
(86) PCT No.: PCT/IB04/50792

§ 371 Date: Dec. 1, 2005

(30) Foreign Application Priority Data
Jun. 5, 2003 (EP) 03101640.5

(51) Int. Cl. G08B 13/14

(52) U.S. Cl. 340/568.1

(57) ABSTRACT

A method is described of safeguarding electronic devices (1, 2, 3, 4) against unauthorized removal, in which one device (1) of the devices (1, 2, 3, 4) is automatically selected as the security device (SG) which transmits a security signal (SS) periodically and/or following receipt of an inquiry signal (RS) from one of the other devices (2, 3, 4). If one of the other devices (2, 3, 4) receives no security signal (SS) after a particular time and/or following transmission of an inquiry signal (RS), a security reaction is triggered by that device (2, 3, 4). A corresponding security system and an electronic device which can be safeguarded in said security system are also described.

The invention relates to a method of safeguarding at least two electronic devices against unauthorized removal. The invention also relates to a corresponding security system for safeguarding at least two electronic devices against unauthorized removal, and to an electronic device which can be protected against unauthorized removal in said security system.

A serious problem with nearly all electronic devices is the possibility that the device might be stolen. The problem is particularly serious with devices in the entertainment electronics field, since such devices are often relatively expensive and—since they are rarely built-in—are frequently easy to steal and high demand and lack of identifiability renders them easy to sell as stolen property. Such a risk of theft arises both in retail outlets in which the devices are offered for sale, and with the subsequent owner at home, where there is a danger that the device will be stolen during a break-in or in the context of a confidence trick. An even greater danger of theft of electronic devices occurs in larger establishments such as companies, institutes, etc., where devices often lie unsupervised in offices, workshops or waiting areas to which many people have access, sometimes with little or insufficient control. With devices which can be misused, for example cell phones, which can be used without the authorization of the owner and at his expense, or devices which contain data that has to be protected, e.g. personal digital assistants (PDAs) or laptops, which can be accessed or even altered by an unauthorized user, there is the additional danger that the device will only be removed temporarily so that the proprietor does not notice the unauthorized use and the device is then returned to its place unnoticed. The term “unauthorized removal of a device” as used below should be understood to encompass not only theft or loss of a portable device, but also unauthorized “loan”, i.e., temporary removal of the device from its designated place or from its designated area or from the vicinity of a person or a vehicle, etc.

Many mechanical security systems already exist for countering unauthorized removal. Examples are chains, wires or other security arrangements, which are seen in many retail outlets to safeguard expensive devices. Many retail outlets often also guard their exits using sensors which detect and trigger an alarm if an unsecured device is removed from the retail outlet without authorization.

Furthermore, European patent application EP-1 306 822 A2 describes a security system for portable electronic devices in which a short range transmitter is arranged in the intended location of the devices to be safeguarded, which transmitter regularly transmits a signal. The devices to be safeguarded each have a receiver unit which receives the signal from the short range transmitter. In addition, the individual devices each have a reaction unit, which produces a warning signal or activates a disabled mode of the device in the event that the receiver no longer receives the signal from the short range transmitter. In that manner, a user can secure his mobile phone, a portable cassette or CD recorder, a laptop etc., as long as the short range transmitter is carried on his body as an additional device. If a device to be safeguarded is removed from the user, whether by theft or because the user loses or misplaces the device, the device triggers an alarm and/or switches it into the disabled mode which renders it unusable by anyone else. In the same manner, a short range transmitter can be used in a retail outlet, office or household to safeguard a plurality of electronic devices.

However, this method has the disadvantage that the whole system is dependent on a special short range transmitter which is provided for transmitting the signals. That short range transmitter must itself be safeguarded by appropriate arrangement in a concealed or safe place, for example, to prevent it from being removed together with the devices. Furthermore, the devices are no longer safeguarded if the short range transmitter breaks down, for example because of lack of power, i.e., in a power cut or if the batteries go flat.

It is an object of the present invention to provide a simple and flexible alternative to those known safeguarding methods.

This object is achieved by means of a safeguarding method in which at least a first device is automatically selected as the security device from among the devices to be safeguarded, which device periodically and/or after receipt of an inquiry signal from another device to be safeguarded transmits a security signal, and in which a security reaction is then triggered by another device to be safeguarded if that device to be safeguarded does not receive a security signal after a given time and/or within a given period following transmission of an inquiry signal.

The object of the invention is also achieved by means of a security system in which each of the devices to be safeguarded has a receiver unit to receive a security signal and a reaction unit which can trigger a security reaction if said device does not receive a security signal after a given time and/or within a given period following transmission of an inquiry signal. Furthermore, a plurality, preferably all of the devices to be safeguarded each have a transmitter unit in order to send out a security signal independently. The devices which have the transmitter units for transmitting a security signal also require a decision unit to automatically decide whether the device independently transmits security signals for the other devices to be safeguarded. The term “decision unit” encompasses all elements within the device—whether in the form of hardware or software, added on as an independent unit or comprising a plurality of components—with the help of which it can be determined whether or when that device transmits a security signal.

With the method or security system of the invention, appointment of a given device to transmit a security signal for other devices is not longer static, but rather, appointment of one of the devices to be safeguarded as the security device for the other devices is a dynamically governed process i.e., the devices concerned safeguard each other, whereby the devices automatically “negotiate” regarding which device carries out the function of the security device. Thus, for example—provided that more than two devices to be safeguarded are available—if the current security device breaks down at any time, then another device can independently take over that function. A special short range transmitter which must be lodged in a secure or concealed place or which must be carried by a user as an additional device, is not necessary. The devices to be safeguarded can be the usual electronic devices, for example devices in the entertainment electronics and communications and information technology fields such as televisions, video recorders, stereo system components, cell phones, PDAs, PCs, laptops, and also devices that are installed in the home such as central heating control devices or household devices such as ovens, microwave ovens, etc. The term “electronic device” can be construed to mean devices which do not have to include electronics for the purposes of their proper function, but have appropriate electronic components so that they can be safeguarded by means of the method of the invention.

The invention advantageously exploits the fact that in the near future most devices will be provided with interfaces via which they can communicate with other devices over a local network. In the home, such networks are termed IHDN: in-home digital networks. With such in home digital networks, very different entertainment electronics devices, telephone services, household appliances, controls, security installations etc can be connected together. A similar situation exists in offices and retail outlets in which more and more local cable and/or wireless networks exist, to which very different devices can be connected. In particular, such networks render sending the corresponding security signals relatively easy. An example of network technology which can be used in the method of the invention is a network which complies with the IEEE802.11 standard or the ZigBee standard. The ZigBee standard has the advantage of requiring relatively little power. However, any other transmission standard is a possibility. In particular, it is possible for the device to have dual mode transmission or reception components, which can switch between different standards. As an example, it would be possible to switch between the IEEE802.11 standard while the device is active and a ZigBee standard while it is in energy-saving mode. Devices which normally have to be connected to the power supply via a cable can also use a so-called “Powerline Communication” network (PLC).

Further, more and more devices, instead of being completely switched off, are put into standby mode, e.g. sleep mode, in which the device per se is no longer functioning and thus saves energy, but particular portions of the device are still active and can for example communicate over a network and be switched into an active state. In such a sleep mode, the devices are consequently also able to receive security signals and to check or themselves transmit. A typical current example of a device which is usually in at least one sleep mode is a videocassette recorder.

The dependent claims contain particularly advantageous implementations and variations of the invention wherein the security system can be further defined in accordance with the method claims.

Generally, the device that has been selected as the security device must also be safeguarded in some manner. Two different methods are possible in this regard.

In one variation, a second device to be safeguarded is selected to be the security response device. This security response device sends a response signal after receiving a security signal, which response signal can then be received by the security device. A security reaction is then triggered by the security device itself if the security device receives no response signal within a given time following transmission of a security signal.

In an alternative, at least two of the devices to be safeguarded are selected as the security device—a main security device and a sub security device—which, for example, transmits the security signal in alternation. In this case, each security device reacts to the security signal from the other security device, providing mutual protection.

Both methods require at least two devices to be safeguarded to be available, which devices are active at least as regards transmission and reception of signals, while it is also possible for these devices to be in standby mode. If in an in-home network a device that is protected anyhow is selected as the security device, for example a large, built-in heating control unit or the like, then additional protection of this device can usually be dispensed with. However, the remaining devices to be safeguarded within the security system must receive the necessary information that the security device is a device that does not have to be safeguarded. Generally, then, mutual complete protection is preferred.

Clearly, the security signal from the devices to be safeguarded or any response signal from the security device must be able to be recognized as said signal. Thus, the security signal or the response signal must be a special signal provided only for this purpose within the network traffic. Alternatively, it may be a portion of a normal regular signal which is always sent by a device in the network.

Preferably, the security signal and any response signal contain a clear identification key which is assigned to the network to which the devices to be safeguarded are connected or to the transmitting device, i.e., the security device or the security response device. A typical network identification key is the so-called SSID within the IEEE802.11 standard. An identification key for the device to be safeguarded can, for example, be the MAC address (medium access control address) or the IP address (internet protocol address) of the security device or the security response device. In these cases, it is necessary for all the devices to be safeguarded to know the network identification key or the identification keys for the other devices or at least the device which can act as the security device. This information can be transmitted to the device, for example, on activation of the security function, upon which the device is logged into a security system already formed by a network of devices. If the individual identification keys of the device are used, then in this case it must also be possible to transmit the identification key of the new device to the remaining devices in the security system. Within most current usual networks it is the case, however, that the individual addresses of the different devices logged into the network will already be known to other devices.

The security signal should preferably not be capable of being replicated by other non-authorized devices. In a particularly preferred embodiment, the identification key is encoded into the security signal or the response signal in such a manner that the security signal or response signal changes constantly. This prevents the security system from being tricked by a potential thief using a portable device to receive, record and shortly thereafter play back the security signal and/or response signal so that one of the devices can be removed, the portable device giving the illusion that the stolen device is in the neighborhood of the security device or security response device. A permanent change in the signal is possible by adding a random value, for example. The encoding should preferably be such that each device, without itself knowing the random number, can identify the part with the identification key and check it.

Portable devices such as laptops, PDAs, cell phones etc in particular must be able as the case may be to be taken beyond a set area where the other devices are located. It is recommended that the security function be carried out in the individual devices so that they can be deactivated at any time by an authorized person. As an example, this can be done by pressing a key on the device and possibly also inputting a password or code via a user interface of the device or by means of a further user-authorized method. Particularly preferably, said deactivation of the antitheft system is only possible if a particular inquiry is made to another device to be safeguarded or by the other device to be safeguarded, in particular the current security device, providing a confirmation. This has the advantage that the remaining devices are simultaneously informed that this device has been removed from the security system.

Since the different devices to be safeguarded are generally constructed differently and carry out different functions, their suitability as a security device is correspondingly different. It is clear that a device which is generally fixed in position and normally never completely switched off, such as a video cassette recorder, is more suitable as a security device than a laptop or cell phone, for example, which the user himself regularly removes from the environs of the other devices to be safeguarded, i.e., beyond the range of the in-home network.

Preferably, then, each device has a priority value assigned to it, which is a measure of the suitability of the device to function as a security device and/or as a security answering device. This priority value is dependent on satisfying particular suitability criteria, for example device type, size and weight, normal position, etc. The device can be provided with this by a user or directly at the factory. The priority value can be selected such that the higher the priority value, the more suitable the device is for use as a security device or security response device. In a preferred embodiment, however, the reverse dependence is provided, i.e., the device with the lowest priority value is the most suitable for use as a security device or security response device.

Particularly preferably, this priority value is used in the method to select a device to be safeguarded as the security device or security response device. One possible procedure when selecting a device to be used as the security device will be described below by way of example.

The selection procedure commences with one of the devices to be safeguarded missing the security signal. It then immediately transmits an inquiry signal in order to prompt the security device into sending a security signal. The period to transmitting such an inquiry signal is shorter than the time after which a security reaction is triggered. If a further device is active within the receiver range, it receives this inquiry signal. It then waits for a given period and then itself transmits a security signal, if it has not already received a security signal from a further device. As soon as the security signal is received by the device that originally transmitted inquiry signal, this device sends a response signal. The device that sent out the security signal then knows that it has been nominated as the security device. The device that has sent the answer is the new security response device.

Setting the time and occasion for transmitting a security signal after elapse of the time can, for example, be made by a decision unit. Preferably, the time to initial transmission of a security signal is dependent on the priority value of that device. This time can, for example, be determined so that the priority value is multiplied by a particular base time—for example 100 milliseconds (ms). If the most suitable potential security device has the lowest priority number, this automatically means that this device will be the first to transmit a security signal and will thus become the new security device.

In the same manner, devices which receive the security signal can transmit a response signal after a particular time which depends on the priority value, for example when an expected response signal fails to appear. In this case, again, the device which is most suited to being the security response device automatically becomes that device.

If two devices transmit a security signal simultaneously, for example if they have the same priority value, it is possible for the devices to negotiate with each other independently regarding which device will act as the security device, for example with the aid of a random number generator, a counter, a timer or based on the address of the device. Such a random number generator can, for example, form part of the decision unit or the decision unit will have access to a random number generator which is used for other purposes. Such a method can also be employed when selecting a new security answering device.

The method described above for locating a suitable security device constitutes only one of many different possibilities. However, it has the advantage of being particularly simple and requiring relatively little data transfer.

The priority value is preferably also sent inside the security signal and/or the response signal. If the priority value of the security device is also transmitted within the security signal, each of the other devices can work out whether it is more suitable than the device which at the time functions as the security device, by comparing the priority value contained within the security signal with its own priority value. In this case, the more suitable device can take over simply be transmitting a security signal which also contains its own priority value. The device that until then has acted as the security device then receives this new security signal and triggers transmission of the security signal. In the same manner, the function of the security response device can be taken over if another device exists that is better suited to the purpose.

The decision unit can, for example, be a suitable comparator unit which can compare the priority value assigned to the device with a priority value in a received security signal or response signal, and can react accordingly.

Analogously, this method can also be used if the system operates with two security devices.

In order to speed up the selection of a new security device, a current security device transmits a logoff signal if it—insofar as it is possible—is switched off or is removed from its position. In this case, the remaining devices to be safeguarded in the system recognize that the current security device has failed. The selection mode for searching for a new security device can then be carried out immediately, for example without any prior inquiry signal, in that the individual devices after a particular time following receipt of a logoff signal, transmit a security signal depending on their priority value. This is also applicable to selecting a new security response device.

Regarding the exact mode of obtaining a security reaction for a device to be safeguarded if the device does not receive a security signal after a given time or within a particular period following transmission of an inquiry signal, a number of possibilities exist:

If the device has a loudspeaker or other unit for emitting acoustic signals, an acoustic warning signal can be emitted. An optical alarm is also possible, for example a distinctive flashing signal on a display or from a LED.

If the device is so far from the security device that it can no longer receive the security signal, but the range is nevertheless sufficient to reach other devices to be safeguarded, suitable information can be transferred to the devices to be safeguarded that can be reached, which can then trigger additional alarms. In particular, any existing home security system or alarm system can be informed and the alarm can be triggered.

It is also possible for special channels, for example in wireless local area networks (WLANs), to be reserved for emergency signals. In this case, a device which is removed without permission can emit a warning to any available network. This information can then be transferred from there to a special internet server, a police station, or security services, for example. Such an implementation requires corresponding standardization. Similarly, a police station, an in-home network, the manufacturer of the device etc can be informed via a cell phone network if the device has a cell phone function.

In addition to the very different alarm functions, the device can also be switched into a particular operating mode, for example disabled mode, in which the device can no longer be used and which can only be recovered using a password or the like. Alternatively, this mode can be ended by the device itself as soon as the device returns to the vicinity of the security device and can again receive the security signal. Other possibilities are that the data relevant to security, for example user-given data, are automatically erased or access to such data is refused.

A further alternative is that the predetermined basic status of each device is the disabled mode, in which the device cannot be used. Thus, every time the device has to carry out a particular function for which it is intended—in particular when the device is switched on—then initially, a check is carried out as to whether it receives a security signal or receives a response signal on transmitting its own security signal. If this is not the case, the device remains in its disabled mode. This means that in such a case the security reaction is that the disabled mode is not removed. Such an organization of the security system is more energy efficient in certain situations and does not require as much bandwidth, as the individual devices are only active in the security system when they are required by the user.

The security reaction can also differ depending on the situation. As an example, the type of security reaction can depend on whether the device is stationary, for example in an in-home network, or is mobile. If a device is used in an in-home network, a loud signal often does not have the desired effect as in most situations devices are removed from private households when the owner is not at home. In such cases, it is possible to send a silent alarm to a monitoring firm or to the nearest police station, a caretaker or to the owner, for example to a cell phone permanently carried by the owner. In contrast, a loud alarm signal is often highly effective when the device is mobile. When used in a mobile situation, the invention simultaneously serves to secure against loss of a device. Thus, devices that are secured in accordance with the invention can no longer fall unnoticed from purses or be inadvertently left somewhere by the user. The alarm function immediately brings this fact to the attention of the user.

In order to be capable of carrying out a security reaction at any time, the components in the device should always be supplied with the necessary power. As an example, this can be done by means of a special battery-powered sub-system within the device, which only monitors receipt of the security signal and triggers the security reaction accordingly. Thus, potential thieves will find it impossible to circumvent the security function by switching the device off or by deliberately interrupting the power supply.

Preferably, the modules in the device relevant to the security system (security control unit, reaction unit) are constructed and arranged in the device so that they are not easy to remove. An unauthorized attempt to remove these modules results, in a particularly preferred implementation, in initiating the corresponding security measures, for example disabling and/or triggering an alarm.

Similarly, long-term receipt of an invalid security signal, i.e. an attempt to imitate the signal, parallel with and/or in the absence of the valid signal, can result in a security reaction.

The variations described above show that the method and security system of the invention are extraordinarily flexible and can be used in very different situations.

Moreover, this system has the advantage that it can also be combined with the system defined above, in which a special short range transmitter is used to transmit the security signal. Thus, for example, a device which is normally safeguarded in the inventive manner in the household of the owner via the in-home network and the available devices can be taken with the owner so that during mobile use the owner carries a special short range transmitter which takes over the function of the normal selected security device within the household network.

To this end, the user simply logs the device to be transported out of the house network and switches it to a mode in which it accepts a security signal from a specially provided mobile transmitter. Preferably, said transfer is made by pressing a key on the device and possibly by inclusive input of a password, etc. In this regard it is indicated that instead of inputting a password, other methods too can be used for checking the authorization of a person to carry out particular actions such as logging a device in or out of the network of the security system. Thus, for example, biometric sensors, speech analysis means, etc can be used in the devices.

Said special mobile security device can also be constructed in the form of a piece of jewelry, a watch, etc, which the user can carry discretely. Furthermore, in the remote future, a user could use a small implanted transmitter. When the user wishes to carry several devices simultaneously, for example a cell phone, a PDA and a Walkman, Discman, etc, which would otherwise form part of a household security network they can also be logged out together and can be reconstituted as a “partial network” for mutual security.

In order to avoid the user having to carry all his mobile devices with him when safeguarding them in accordance with the invention, an additional function can be provided whereby the user deliberately and temporarily switches off the security function, for example if he leaves a bag with the devices to be safeguarded with a colleague for security, for example to visit the rest rooms. In order not to trigger the alarm in such cases, then preferably a key press—perhaps after inputting a special code or using a further authorization method—will suppress at least the audible alarm. To this end, the device can transmit a logoff signal, which informs the other devices of the removal. The devices can then go into a temporary disabled mode. As soon as the device correctly registers the security or response signal again, then the full security function is re-established.

These and other aspects of the invention are apparent from and will be elucidated, by way of non-limitative example, with reference to the embodiment(s) described hereinafter.

In the drawings:

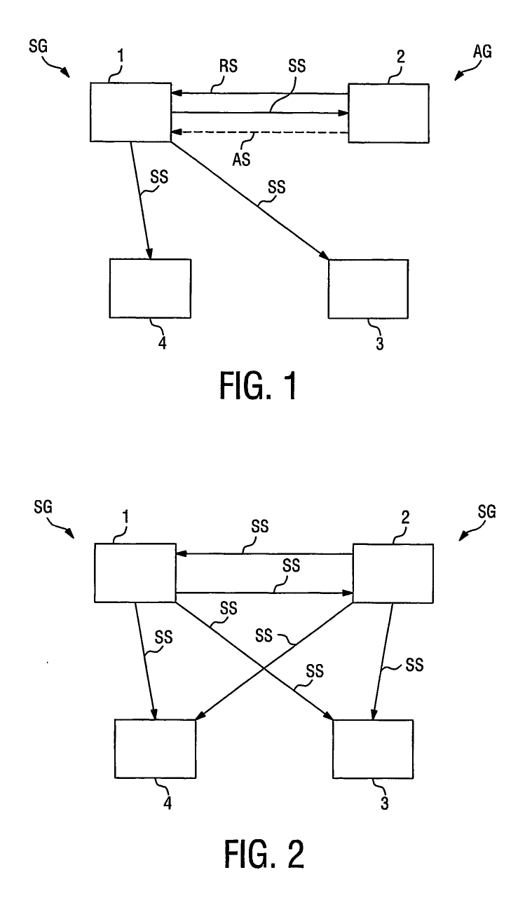

FIG. 1 shows a first embodiment of a security system of the invention with four devices to be safeguarded;

FIG. 2 shows a second embodiment of a security system of the invention with four devices to be safeguarded;

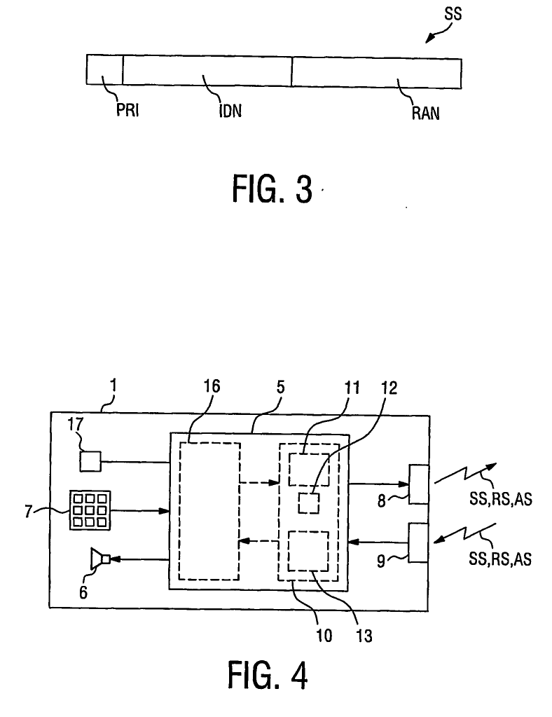

FIG. 3 shows a diagram of a security signal;

FIG. 4 shows a block diagram which illustrates the arrangement and cooperation of different functional units in a device to be safeguarded.

FIGS. 1 and 2 show each a non-limiting embodiment of the invention which concern four devices 1, 2, 3, 4, for example a TV 1, a video cassette recorder 2, a stereo system 3 and a microwave device 4, which are to be safeguarded.

The embodiment shown in FIG. 1 shows a system which operates with only one security device SG, which regularly transmits security signals SS to the other devices 2, 3, 4 in a broadcast or unicast mode. The range of the security signal SS is such that all devices in the network can receive the security signal SS. In a broader variation for more spaced out networks, devices could be used which pass on the signal. This security device SG was selected from the devices 1, 2, 3 4 as the security device; the method will be described below. In addition, a security response device AG was selected from devices 1, 2, 3, 4 to be safeguarded, which transmits a response signal AS after receiving the security signal SS. This response signal AS informs the security device SS that it is still in range of the devices to be safeguarded 2, 3, 4.

In the system shown, TV 1 functions as the security device SG and the video cassette recorder 2 functions as the security response device AG. Alternatively, these functions can be taken on by the other devices 3, 4.

The possible construction of a security signal SS can be seen in FIG. 3. The security signal SS in this case is formed by a data string which is coded in a given manner. A portion of the data string contains a so-called priority value PRI assigned to the device that transmits the security signal SS. A further portion comprises an individual IDN identification key for the device, which transmits the security signal SS. This individual IDN identification key enables the other devices 2, 3, 4 to recognize whether the security signal SS is being transmitted by the correct device, i.e. whether it is a true security signal SS. A third portion of the data string is formed by a random number RAN which is generated by a random number generator in the transmitting device, i.e. in the current security device SG. With this random number RAN, which changes with each transmission of a new security signal, the security signal changes constantly, i.e. successive security signals SS are not identical. Therefore, it is impossible to pick up the security signal simply with a suitable device, to store it and then re-transmit it and in this manner to take away a device to be safeguarded in an unauthorized manner, by simulating the proximity of the security device SG by transmitting the stored security signal SS. The response signal AS is constructed in a similar manner.

FIG. 4 shows the architecture of various components in a security device 1. For simplicity, only the components essential to the security function of the invention are shown in FIG. 4. All further components which are necessary for the main function of the device—for example to function as a TV—are only shown to the extent that they are used for the security method.

Two essential components of device 1 for use as the security device SG in the security system are the short range (for example 10-50 m) transmitter 8, which can transmit security signals SS, inquiry signals RS or response signals AS, and a receiver unit 9, via which the corresponding security signals SS, inquiry signals RS and response signals AS can be received from other devices. Instead of a separate transmitter unit and separate receiver unit, a combined transceiver can be used.

Device 1 also has a security control unit 10 which controls inter alia the transmitter unit 8 and receiver unit 9 and enables transmission of the desired signals or the receipt of the required signal. This security control unit 10 can, for example, be in the form of a suitable software module on a central processor 5 of the device 1, on which a general device control 16 is formed, required to control the device-given functions, e.g. as a TV. In principle, the security control unit 10—for example a software module—can also be part of the general device control unit 16.

In addition, the device contains a storage battery 17, which charges up when the device is connected to a power circuit and which supplies the processor 5 and other components with power when the power supply fails so that the security function can function properly for a further period. Alternatively, a simple replaceable battery could be used.

One element of the security control unit 10 is a reaction unit 13, which can be a sub-routine of the security control unit 10. This reaction unit 13 ensures that a security reaction occurs if device 1 or security control unit 10 receives no security signal SS via the receiver unit 9 or receives no response signal AS following transmission of a security signal SS.

As an example, as shown in FIG. 4, it can be a corresponding command to the device control 16, via which specific reactions are triggered in the device control 16. As an example, an acoustic alarm can be triggered through the usual loudspeaker 6 of the TV. In addition, an optical alarm can be emitted on a display (not shown) of the television. Further, the device control unit 16 of device 1 can be switched into a disabled mode in which device 1 can no longer be used.

Further components of the security control unit 10, which can for example be implemented in the form of subroutines or software modules in the central processor 5 of the device, are a decision unit 11 and a random number generator 12 to which decision unit 11 should have access. The random number generator 12 can then also be part of the decision circuit 11. Decision unit 11 determines when device 1 transmits a security signal SS itself. This means that this decision unit 11 ensures that the function of the security device SG can, within a group of devices 1, 2, 3, 4 to be safeguarded, be automatically established by devices 1, 2, 3 and 4.

The security components of the other devices 2, 3, 4 are constructed in a manner identical to or different from device 1 shown in FIG. 4 and each have a transmitter unit 8, a receiver unit 9, a security control unit 10 with a decision unit 11, a random number generator 12 and a reaction unit 13.

The security reaction, which is triggered by the reaction unit 13, can differ depending on the type of device. As an example, with a stereo system 3, which has a loudspeaker, a corresponding alarm can be triggered. With other devices with no acoustic elements, such as a video cassette recorder or a microwave, the device is only switched into a disabled mode in which it can no longer be used, so that a potential thief finds that it is not worth stealing the device.

The function of the decision unit 11, i.e., finding out whether the device operates as the security device SG, will be illustrated below in a situation in which all devices 1, 2, 3, 4 have failed and thus temporarily, no more security signals SS can be transmitted.

After switching on devices 1, 2, 3, 4 again, the individual devices 1, 2, 3, 4 each try to receive a security signal SS. After devices 1, 2, 3, 4 have tried to receive a security signal SS for a particular time period, then at least one of devices 1, 2, 3, 4—in this case video cassette recorder 2—will transmit an inquiry signal RS. This inquiry signal RS will be received by the other devices 1, 3, 4.

It will be assumed below that all of the devices have different PRI priority values which represent the suitability of these devices 1, 2, 3, 4 to act as a security device SG. This setup is such that a device with the lowest PRI priority value is the most suitable to act as the security device SG, whereas devices with higher priority values are less suitable. Particularly suitable devices are those devices which are only seldom switched off and are usually switched into a standby mode, such as a television. Other devices, on the other hand, such as microwave 4, which are regularly switched off, are not as suitable and receive a higher PRI priority value.

Preferably, it is not necessarily the devices with the highest priority value that transmit an inquiry signal AS first, in order to seek another device which is suitable for use as the security device.

Following receipt of the inquiry signal RS, all devices wait for a given period—for example 100 ms multiplied by their priority value—and then independently send a security signal SS as long as they have not themselves already received a security signal SS. Multiplication of a set base time which is the same for all devices by the priority value of the device ensures that devices with the lowest priority, i.e. devices which are the most suitable security devices, automatically transmit a security signal SS. Determination and keeping to the waiting period until transmission of a security signal is the task of the decision unit 11. In the case shown in FIG. 1, the TV 1 is the first to send the security signal.

All other devices 2, 3, 4 and the originally queried device 2 then receive this security signal SS. After the security signal SS has been received by the originally queried device 2, device 2 responds with a response signal AS. This response signal AS informs device 1 which has transmitted the security signal that it has now been accepted as the security device SG and must transmit future security signals SS.

Device 2 which originally transmitted the inquiry signal RS automatically functions as the security response device AG, which will also regularly transmit future response signals AS, to safeguard the security device SG itself.

In order that the individual devices 1, 2, 3, 4 can respectively recognize the security signal SS of the security device SG, independently of which of devices 1, 2, 3, 4 functions as the security device SG, all devices 1, 2, 3, 4 must be informed of the individual IDN identification key of the other devices 1, 2, 3, 4.

This is possible, for example, by transmitting a special identification inquiry signal from a device when initially logging it into a network of devices forming a security system, whereupon all devices that are already in the network send back their individual IDN identification keys and possibly other information. These data are then stored in the new device. The new device sends its own IDN identification key to the other devices, for example with the ID inquiry signal. Said logging in of a device into a network of different devices to be safeguarded clearly only occurs with the particular authorization of the user, for example after inputting a code word or a PIN. This can be accomplished using the keypad 7 (see FIG. 4) of device 1 while it may be the keypad on the usual user interface for device 1, for example a TV or video cassette recorder, or a remote control. A device can also only be logged out of the device network forming the security system without triggering the alarm function after inputting a PIN or other password using another user-authorized method.

If a device in the embodiment shown in FIG. 1 is to be freshly logged in, for example, which device would be better suited to acting as the security device SG than the current device 1 which is acting as the security device SG, this new device can establish this fact simply by using the PRI priority value (see FIG. 3) transmitted in the security signal SS. To this end it is simply necessary that e.g. the decision unit 11 of the new device compares the PRI priority value of the security signal SS with its own priority value. If the PRI priority value in the security signal SS is higher than its own priority value, that device is better suited than the currently active security device SG. Thus, the new device automatically sends a security signal. As soon as the currently active security device SG receives the new security signal, it also compares the priority values and stops transmission of the security signals—after it has checked that it has a lower priority value than the other device.

If by chance two devices simultaneously transmit security signals which have the same priority value, the decision unit 11 can decide with the help of the random number generator 12 which of the devices will function as the security device. As an example, both “competing” devices can produce a random number using their random number generators 12, and the device with the highest or lowest random number then functions as the security device SG.

FIG. 2 shows a somewhat different model than the four mutually protectable devices 1, 2, 3, 4 of FIG. 1. The main difference between the embodiment of FIG. 1 and the embodiment of FIG. 4 is that here, two security devices SG operate in parallel and thus a security response device AG is no longer required. Both security devices SG transmit the security signal SS in alternation, and thus protect both the other devices 3, 4 and each other.

Finally, it should be mentioned again that the security systems shown in the Figures and the description and the internal construction of an electronic device for use in such a security system are given solely by way of example and the skilled person could provide many variations without departing from the scope of the invention. In particular, as an example, the security signal can be built up in a completely different manner; as an example, instead of an individual identification key for the individual devices, a common identification key for a defined network could be used. Instead of a keypad, a speech input/output with an automatic speech recognition system can be used as the user interface. Instead of transmitter and reception units 8, 9, which only transmit and receive wirelessly within a defined range in which the devices should be located, said transmitter and receiver units could also transmit and receive signals over a mains network, for example via the mains power supply. Further, instead of using a general processor in the device to implement the security function in the device, a (smaller) processor of its own can be built-in which is connected with a completely stand-alone power supply in the device.

Further, the term “transmitter unit” as used in the present text means any apparatus which generates and transmits the required signals, and does not have to be a physical unit, i.e. the named functions—generation of signals and transmission of signals—can also be carried out by different components.

Moreover, for completion, it is indicated that the use of the indefinite article “a” or “an” does not exclude the possibility that a plurality of those features could be present and that the use of the term “comprise” does not exclude the existence of further elements.

1. A method of safeguarding at least two electronic devices (1, 2, 3, 4) against unauthorized removal, in which:
at least a first device (1) is automatically selected as the security device (SG) from among the devices (1, 2, 3, 4), which device transmits a security signal (SS) periodically and/or after receipt of an inquiry signal (RS) from one of the other devices (2, 3, 4);
and a security reaction is triggered by one of the other devices (2, 3, 4) if the device in inquiry receives no security signal (SS) after a given time and/or within a given period following transmission of an inquiry signal (RS).

2. A method according to claim 1, characterized in that a second device (2) is automatically selected as the security response device (AG), which transmits a response signal (AS) following receipt of a security signal (SS) and in that a security reaction is triggered by the security device (SG) if the security device (SG) receives no response signal (AS) within a particular period following transmission of a security signal (SS).

3. A method according to claim 1 or claim 2, characterized in that at least two devices (1, 2) are selected as security devices (SG), which transmit a security signal (SS) periodically and/or following receipt of an inquiry signal (RS), and a security reaction is triggered by one of the security devices (SG) if that security device (SG) receives no security signal (SS) from the other security device (SG) after a particular time and/or within a particular period following transmission of an inquiry signal (RS).

4. A method according to any one of claims 1 to 3, characterized in that the security signal (SS) and/or the response signal (AS) is connected to a network to which the devices (1, 2, 3, 4) are connected, and/or the transmitting device (SG, AG) contains a uniquely assigned identification key (IDN).

5. A method according to any one of claims 1 to 4, characterized in that the identification key (IDN) is encoded into the security signal (SS) and/or the response signal (AS) in a manner such that the security signal (SS) and/or the response signal (AS) is constantly changed.

6. A method according to any one of claims 1 to 5, characterized in that each device (1, 2, 3, 4) is assigned a priority value (PRI) which is a measure of the suitability of that device (1, 2, 3, 4) to act as the security device (SG) and/or secure answer device (AG).

7. A method according to claim 6, characterized in that the security signal (SS) and/or the response signal (AS) contains the priority value (PRI) assigned to the respective device (SG, AG) transmitting the signal (SS).

8. A method according to claim 6 or claim 7, characterized in that selection of one of the devices (1, 2, 3, 4) as the security device (SG) or as the security response device (AG) is accomplished using a given procedure having due regard to the priority values assigned to the individual devices (1, 2, 3, 4).

9. A method according to any one of claims 6 to 8, characterized in that a device with a priority value which represents better suitability of that device to act as the security device than that of the priority value of the current security device itself transmits a security signal and takes over transmission of further security signals following receipt of said security signal.

10. A method according to any one of claims 1 to 9, characterized in that the security device, if it is switched off, firstly transmits a logoff signal which indicates to the devices to be safeguarded that no more security signals will be transmitted by the security device and hence a further device will automatically be selected as the security device from the remaining devices.

11. A method according to any one of claims 1 to 10, characterized in that a device, if it receives no security signal after a particular time and/or within a particular period following transmission of an inquiry signal and/or if it receives a logoff signal from the current security device, itself transmits a security signal and waits for a particular period for a response signal.

12. A method according to any one of claims 6 to 10 and claim 11, characterized in that the period to the initial transmission of its own security signal by the device depends on the priority value of that device.

13. A security system for safeguarding at least two electronic devices (1, 2, 3, 4) against unauthorized removal having:
a receiver unit (9) in each device (1, 2, 3, 4) to receive a security signal SS;
a reaction unit (13) in each device (1, 2, 3, 4) to trigger a security reaction if said device (1, 2, 3, 4) does not receive a security signal (SS) after a given time and/or within a given time period following transmission of an inquiry signal (RS);
a transmitter unit (8) in a plurality of the devices (1, 2, 3, 4), to transmit a security signal (SS) independently;
and a decision unit (11) in the devices (1, 2, 3, 4) having transmitter units (8) for transmitting a security signal (SS), to automatically decide whether the device (1, 2, 3, 4) is independently transmitting security signals (SS).

14. An electronic device (1, 2, 3, 4) which can be safeguarded in a security system according to claim 13, having:
a receiver unit (9) for receiving a security signal (SS);
a reaction unit (13) to trigger a security reaction if the device (1, 2, 3, 4) receives no security signal (SS) after a given time and/or within a particular period following transmission of an inquiry signal (RS);
a transmitter unit (8) for transmitting a security signal (SS); and
a decision unit (11) to automatically decide whether the device (1, 2, 3, 4) is independently transmitting security signals (SS).
